(19) United States
(12) Patent Application Publication
(10) Pub. No.: US 2002/0015090 A1
(43) Pub. Date: Feb. 7, 2002

(54) Scanning optical apparatus and image forming apparatus

(76) Inventors: Yasuo Suzuki, Shizuoka (JP); Hidekazu Shimomura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/851,157

(22) Filed: May 9, 2001

(30) Foreign Application Priority Data
May 10, 2000 (JP) 137469 / 2000
May 7, 2001 (JP) 136238 / 2001

(51) Int. Cl. B41J 2/435

(52) U.S. Cl. 347/243

(57) ABSTRACT

An object of the present invention is to provide an image forming apparatus that has a light source, deflecting device for deflecting light emitted from the light source by a rotation, a mirror for deflecting the light deflected by the deflecting device, an image bearing body to which the light deflected by the mirror is irradiated, and a lens for image-forming the light deflected by the deflecting device onto the image bearing body, wherein a plurality of lights are deflected by the one deflecting device and only the one mirror exists in an optical path along which the one light deflected by the deflecting device reaches the image bearing body.

### BACKGROUND OF THE INVENTION

1. Field of the Invention

The invention relates to a scanning optical apparatus which is used in a copying apparatus, a printer, a facsimile apparatus, or the like and to an image forming apparatus having such a scanning optical apparatus.

2. Related Background Art

Hitherto, in an optical scanning apparatus which is used in a luminous flux printer (LBP), a digital copying apparatus, or the like, a luminous flux which was light modulated and emitted from light source means in accordance with an image signal is periodically deflected by a light deflector comprising, for example, a rotary polygon mirror (polygon mirror), is focused like a spot onto the surface of a recording medium (photosensitive drum) having photosensitive performance by a scanning optical device (imaging device) having f÷ characteristics, and optically scans onto the recording medium surface, thereby recording an image.

FIG. 6 is a schematic diagram of a main section of such a kind of conventional scanning optical apparatus.

In the scanning optical apparatus shown in FIG. 6, a divergent luminous flux emitted from light source means 91 is converted into an almost parallel luminous flux by a collimator lens 92 and the luminous flux (light amount) is restricted by a diaphragm 93 and enters a cylinder lens (cylindrical lens) 94 having a predetermined refractive index only in the subscanning direction. The almost parallel luminous flux which entered the cylinder lens 94 is emitted in a main scanning cross section as it is in a state of the almost parallel luminous flux, while in a subscanning cross section, it is converged and formed as an almost line image onto a deflecting surface (reflecting surface) 95a of a light deflector 95 comprising a rotary polygon mirror (polygon mirror).

The luminous flux deflected and reflected by the deflecting surface 95a of the light deflector 95 is guided onto a photosensitive drum surface 98 as a scanned surface through a scanning optical device (fΘ lens) 96 having fΘ characteristics and optically scans onto the photosensitive drum surface 98 in the direction of an arrow B by rotating the light deflector 95 in the direction shown by an arrow A, thereby recording an image onto the photosensitive drum surface 98 as a recording medium.

In recent years, a color image forming apparatus having an optical apparatus for performing a plurality of (for example, four) scans has been proposed (refer to Japanese Patent Application Laid-Open Nos. 6-183056 and 10-186254).

However, such a kind of conventional color image forming apparatus using a plurality of folding mirrors has a problem such that an inclination and a position of each of the plurality of folding mirrors is changes due to an environmental fluctuation and an irradiating position of the scanning optical apparatus largely fluctuates.

In case of using a plurality of folding mirrors, there is also a problem such that an occupied volume of the scanning optical apparatus itself is large and the color image forming apparatus increases in size.

Further, in the case where a plurality of (for example, four) scanning optical apparatuses are used in parallel as they are, since costs of the scanning optical apparatus are high, the color image forming apparatus becomes expensive.

### SUMMARY OF THE INVENTION

It is an object of the invention to provide a scanning optical apparatus and an image forming apparatus which can suppress a fluctuation of an irradiating position.

Another object of the invention is to provide an image forming apparatus comprising: a light source; deflecting means for deflecting light emitted from the light source by a rotation; a mirror for deflecting the light deflected by the deflecting means; an image bearing body to which the light deflected by the mirror is irradiated; and a lens for image-forming the light deflected by the deflecting means onto the image bearing body, wherein a plurality of lights are deflected by the one deflecting means and only the one mirror exists in an optical path until the one light deflected by the deflecting means reaches the image bearing body.

Still another object of the invention is to provide an image forming apparatus comprising: a light source; deflecting means for deflecting light emitted from the light source by a rotation; a mirror for deflecting the light deflected by the deflecting means; an image bearing body to which the light deflected by the mirror is irradiated; and a lens for image-forming the light deflected by the deflecting means onto the image bearing body, wherein in an optical path along which the light deflected by the deflecting means is directed toward the image bearing body, the lens is provided on a downstream side of the mirror.

Further another object of the invention is to provide a scanning optical apparatus comprising: a light source; deflecting means for deflecting light emitted from the light source by a rotation; a mirror for deflecting the light deflected by the deflecting means; and a lens through which the light deflected by the mirror is transmitted.

The other objects and features of the present invention will become apparent from the following detailed description and the appended claims with reference to the accompanying drawings.

### BRIEF DESCRIPTION OF THE DRAWINGS

FIG. 1 is a diagram showing an image forming apparatus according to an embodiment of the invention;

FIG. 2 is a diagram showing a scanning optical apparatus according to an embodiment of the invention;

FIG. 3 is a plan view of the scanning optical apparatus;

FIG. 4 is a diagram showing a scanning optical apparatus according to another embodiment of the invention;

FIG. 5 is a diagram showing a scanning optical apparatus according to still an other embodiment of the invention;

FIG. 6 is a diagram showing a conventional scanning optical system;

FIG. 7 is a diagram showing a scanning optical system of the invention; and

FIG. 8 is a diagram showing a scanning optical apparatus of the invention.

### DETAILED DESCRIPTION OF THE PREFERRED EMBODIMENTS

An embodiment of the invention will now be described hereinbelow with reference to the drawings.

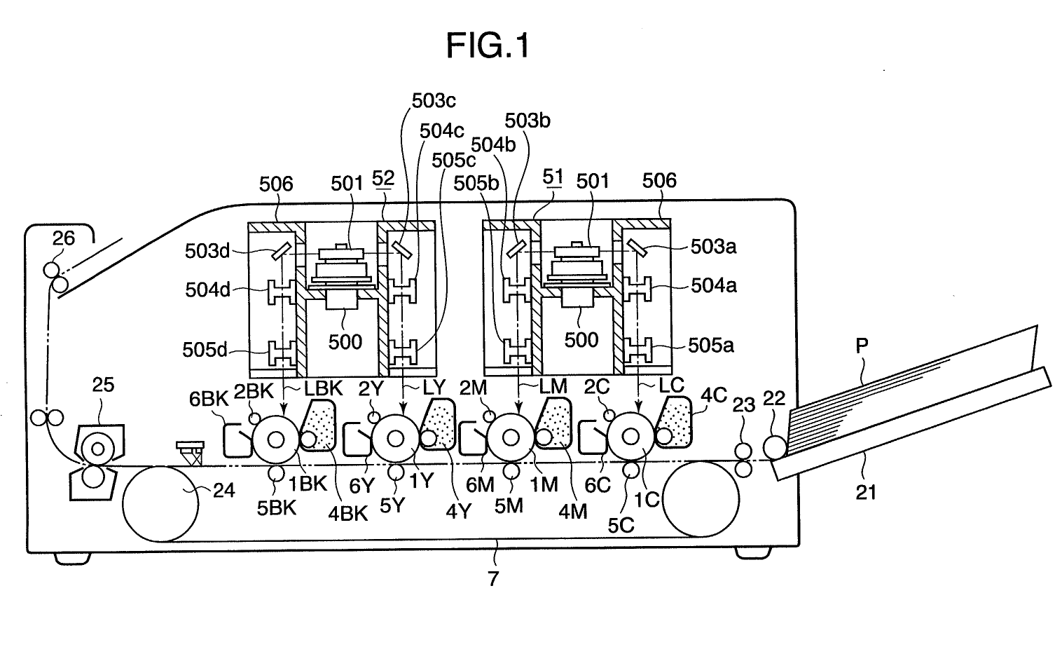

FIG. 1 is a schematic cross sectional view of a main section of a color image forming apparatus according to the invention. In FIG. 1, reference numerals 51 and 52 denote scanning optical apparatuses; 1C, 1M, 1Y, and 1BK denote image bearing bodies; 2C, 2M, 2Y, and 2BK primary charging devices; 4C, 4M, 4Y, and 4BK developing devices; 5C, 5M, 5Y, and 5BK transferring rollers; and 6C, 6M, 6Y, and 6BK cleaners.

The image bearing bodies 1C, 1M, 1Y, and 1BK have uniformly been charged by the primary charging devices 2C, 2M, 2Y, and 2BK, respectively. Luminous fluxes (laser beams) LC, LM, LY, and LBK which were light modulated on the basis of image information are irradiated onto the surfaces of the corresponding image bearing bodies 1C, 1M, 1Y, and 1BK, respectively, so that latent images are formed onto the image bearing bodies 1C, 1M, 1Y, and 1BK, respectively. The latent images are visualized to images of cyan, magenta, yellow, and black by the developing devices 4C, 4M, 4Y, and 4BK, respectively. The images are sequentially transferred by the transferring rollers 5C, 5M, 5Y, and 5BK onto a transferring material P serving as a recording material which is conveyed on a transferring belt 7, respectively, so that a color image is formed. Residual toner remaining on the surfaces of the image bearing bodies 1C, 1M, 1Y, and 1BK is removed by the cleaners 6C, 6M, 6Y, and 6BK. The image bearing bodies 1C, 1M, 1Y, and 1BK are uniformly charged again by the primary charging devices 2C, 2M, 2Y, and 2BK in order to form a next color image, respectively.

The transferring materials P are stacked on a sheet feeding tray 21. The transferring materials P are sequentially fed one by one by a sheet feeding roller 22 and conveyed onto the transferring belt 7 synchronously with an image writing timing by registration rollers 23. The cyan image, magenta image, yellow image, and black image formed on the surfaces of the image bearing bodies 1C, 1M, 1Y, and 1BK are sequentially transferred onto the transferring material P while the transferring material P is precisely conveyed on the transferring belt 7, so that a color image is formed. A driving roller 24 accurately conveys the transferring belt 7 and is connected to a driving motor (not shown) whose rotational unevenness is small.

The color image formed on the transferring material P is thermally fixed by a fixing device 25. The transferring material P on which the color image has thermally been fixed is conveyed by sheet discharging rollers 26 and the like and delivered outside of the apparatus.

The scanning optical apparatus 51 emits the luminous fluxes LC and LM for scanning the image bearing bodies 1C and 1M. The scanning optical apparatus 52 emits the luminous fluxes LY and LBK for scanning the image bearing bodies 1Y and 1BK.

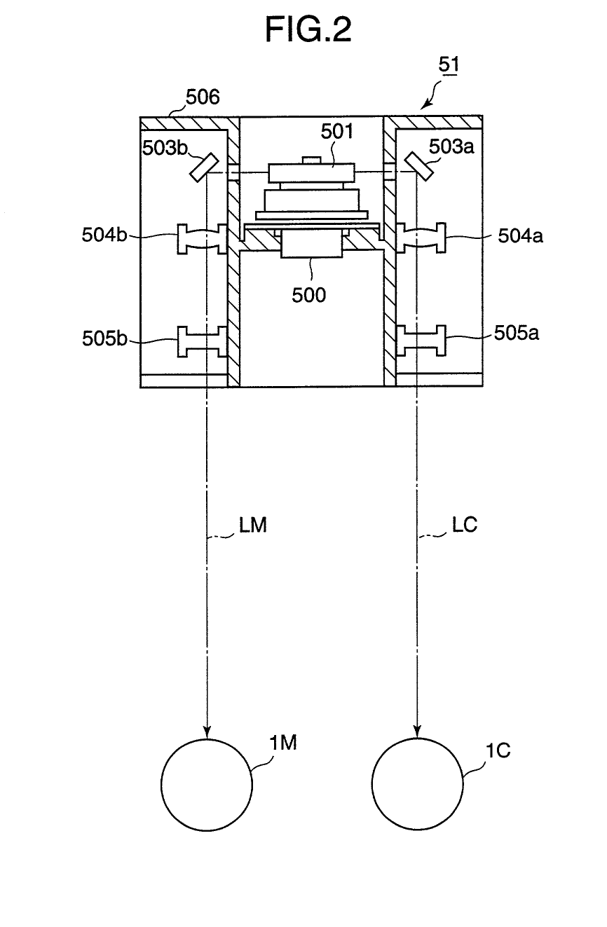

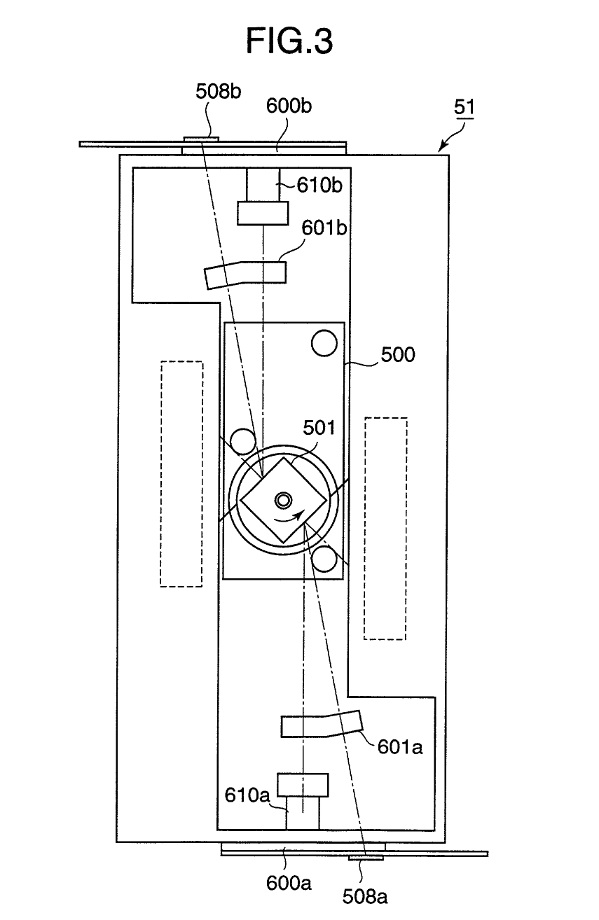

A construction of the scanning optical apparatus 51 will now be described in detail with reference to FIGS. 2 and 3. Since a construction of the scanning optical apparatus 52 is substantially the same as that of the scanning optical apparatus 51, its explanation is omitted here.

FIG. 2 is a cross sectional view of the scanning optical apparatus 51 and FIG. 3 is a plan view of the scanning optical apparatus 51. In those figures, reference numeral 506 denotes an optical box. The following component elements are attached to the optical box 506, that is: laser units 600a and 600b for converting the luminous fluxes LC and LM emitted from semiconductor lasers 610a and 610b as light sources into almost parallel lights; cylindrical lenses 601a and 601b for forming the luminous fluxes LC and LM as a line image on the reflecting surface of a rotary polygon mirror 501; a deflector 500 as deflecting means having the polygon mirror 501 so as to deflect and scan the luminous fluxes LC and LM by a rotation; beam detecting sensors (hereinafter, referred to as BD sensors) 508a and 508b for obtaining a write sync signal; folding mirrors 503a and 503b for folding and deflecting the deflected luminous fluxes LC and LM; scanning lenses 504a, 504b, 505a, and 505b for image-forming the luminous fluxes LC and LM onto the image bearing bodies 1C, 1M, 1Y, and 1BK; and the like.

In the scanning optical apparatus 51 as mentioned above, the laser units 600a and 600b, cylindrical lenses 601a and 601b, BD sensors 508a and 508b, folding mirrors 503a and 503b, and scanning lenses 504a, 504b, 505a, and 505b are provided for two systems (two systems of cyan and magenta), respectively. However, one deflector 500 having the rotary polygon mirror 501 and one optical box 506 realize the functions of two systems.

In the scanning optical apparatus 51, one deflecting means 500 deflects two lights. Only one mirror (503a or 503b) exists in an optical path along which one light deflected by the deflecting means 500 reaches the image bearing body (1C or 1M).

The scanning optical apparatus 52 is similar to the scanning optical apparatus 51. With respect to the whole image forming apparatus, there are four mirrors and four image bearing bodies and the mirror and the image bearing body are provided for each of the four lights deflected by the two deflecting means 500. An arrangement pitch of the mirrors and that of the image bearing bodies are almost the same.

According to the embodiment as mentioned above, since the deflecting means is constructed by two deflecting means and one scanning system is constructed by one folding mirror, a fluctuation of the irradiating position due to an environmental fluctuation of the scanning optical apparatus can be suppressed and the costs of the scanning optical apparatus can be reduced. By making the arrangement pitch of the folding mirrors coincide with that of the image bearing bodies, there are effects such that the image bearing bodies can be arranged in the same plane and the positioning and exchange of the image bearing bodies can be easily performed.

In the scanning optical apparatus 51, the laser units 600a and 600b, cylindrical lenses 601a and 601b, folding mirrors 503a and 503b, and scanning lenses 504a, 504b, 505a, and 505b are symmetrically arranged around the deflector 500 as a center. Similarly, also in the scanning optical apparatus 52, the laser units and cylindrical lenses, and the folding mirrors 503c and 503d and scanning lenses 504c, 504d, 505c, and 505d shown in FIG. 1 are symmetrically arranged around the deflector 500 as a center. Therefore, the distances from each rotary polygon mirror 501 to the image bearing bodies 1C, 1M, 1Y, and 1BK can be equalized. Thus, the four image bearing bodies 1C, 1M, 1Y, and 1BK can be arranged on the same plane without a stairway. The positioning and exchange of the image bearing bodies 1C, 1M, 1Y, and 1BK can be easily performed.

Since it is sufficient to use two deflectors 500 and two rotary polygon mirrors 501, the costs of the apparatus can be fairly reduced.

In the embodiment shown in FIGS. 1 and 2, the folding mirrors are arranged near the polygon mirror, that is, in an optical path along which the light deflected by the deflecting means is directed toward the image bearing body, the lens is provided on the downstream side of the mirror, so that there is the following advantages, which will be explained hereinlater.

According to the ordinary scanning optical system, to correct an unevenness of pitch due to a surface inclination of the polygon mirror, the deflecting surface of the polygon mirror and the photosensitive body drum surface are constructed so as to have a conjugate relation in the subscanning direction. Therefore, even if the polygon surface is inclined in the subscanning direction, the luminous flux can always scan on one certain scanning line on the photosensitive drum by the lens for correcting the inclination of the reflecting surface of the polygon mirror (surface inclination correcting effect). The folding mirrors in the scanning optical system increase a degree of freedom of arrangement by folding the optical path and contribute to the realization of a compact size of the optical system. However, their arrangement is considered by paying attention only to the foregoing point. Ordinarily, they are arranged between the scanning lens and the photosensitive drum. However, if the folding mirrors are arranged near the deflecting surface like an embodiment shown in FIGS. 1 and 2, the inclination and bending of the scanning line due to a variation in positional precision of the folding mirror become hard to occur owing to the surface inclination correcting effect described above. It is particularly an important advantage in the color image forming apparatus having a plurality of scanning optical apparatuses and the photosensitive drums corresponding thereto. In the color image forming apparatus, in order to accurately overlap four color images, a detecting mechanism to detect an amount of color registration and various correcting mechanisms to feedback-correct a detection amount are provided. Particularly, since the inclination and bending of the scanning line cannot be electrically corrected, hitherto, they have been cancelled by a method whereby a part of the optical system or the scanning optical apparatus itself is deviated for the purpose of correction of the inclination or a method whereby a part of the optical system is deviated to thereby cause a bending in the opposite direction for the purpose of correction of the bending. Since the color image forming apparatus has such an adjusting mechanism of a large scale, there is a problem such that its costs are high.

Table 1 shows a fluctuation amount of the scanning line according to each image height in the case where the folding mirror of the scanning optical system, which will be described hereinlater, is shifted in the optical axial direction (x axis) by 50 μm, the case where it is rotated by 3 arcmin around an axis (y axis), as a center, that is parallel with the main scanning direction, and the case where it is rotated by 3 arcmin around an axis (z axis), as a center, that is perpendicular to the x and y axes (refer to FIG. 8 for each axis). Thus, the fluctuation amount is equal to 6 μm even in case of the maximum bending, it is equal to 5 μm even in case of the maximum inclination, and these values are very small. It is possible to construct the scanning optical system of a small color deviation (bending and inclination) which is suitable for the color image forming apparatus having a plurality of scanning optical apparatuses. Consequently, the adjusting mechanism can be simplified and the cheap color image forming apparatus can be provided.

TABLE 1
ΔZ (scanning line height) sensitivity

| Change | | | |
|---|---|---|---|
| amount | | | |
| Image | X-shift | Y-rot | Z-rot |
| height | 0.05 mm | 3 arcmin | 3 arcmin |
| 106.8 | −0.107 | 0.055 | −0.001 |
| 96.1 | −0.108 | 0.058 | −0.001 |
| 85.4 | −0.109 | 0.057 | 0.000 |
| 74.8 | −0.110 | 0.058 | 0.000 |
| 64.1 | −0.111 | 0.059 | 0.000 |
| 53.4 | −0.112 | 0.059 | 0.000 |
| 42.7 | −0.113 | 0.060 | 0.000 |
| 32.0 | −0.114 | 0.060 | 0.000 |
| 16.0 | −0.115 | 0.061 | 0.000 |
| 0.0 | −0.116 | 0.061 | 0.000 |
| −16.0 | −0.116 | 0.060 | 0.000 |
| −32.0 | −0.116 | 0.060 | 0.000 |
| −42.7 | −0.116 | 0.059 | −0.001 |
| −53.4 | −0.115 | 0.058 | −0.001 |
| −64.1 | −0.115 | 0.058 | −0.001 |
| −74.8 | −0.114 | 0.057 | −0.002 |
| −85.4 | −0.113 | 0.056 | −0.002 |
| −96.1 | −0.112 | 0.055 | −0.002 |
| −106.8 | −0.112 | 0.055 | −0.003 |

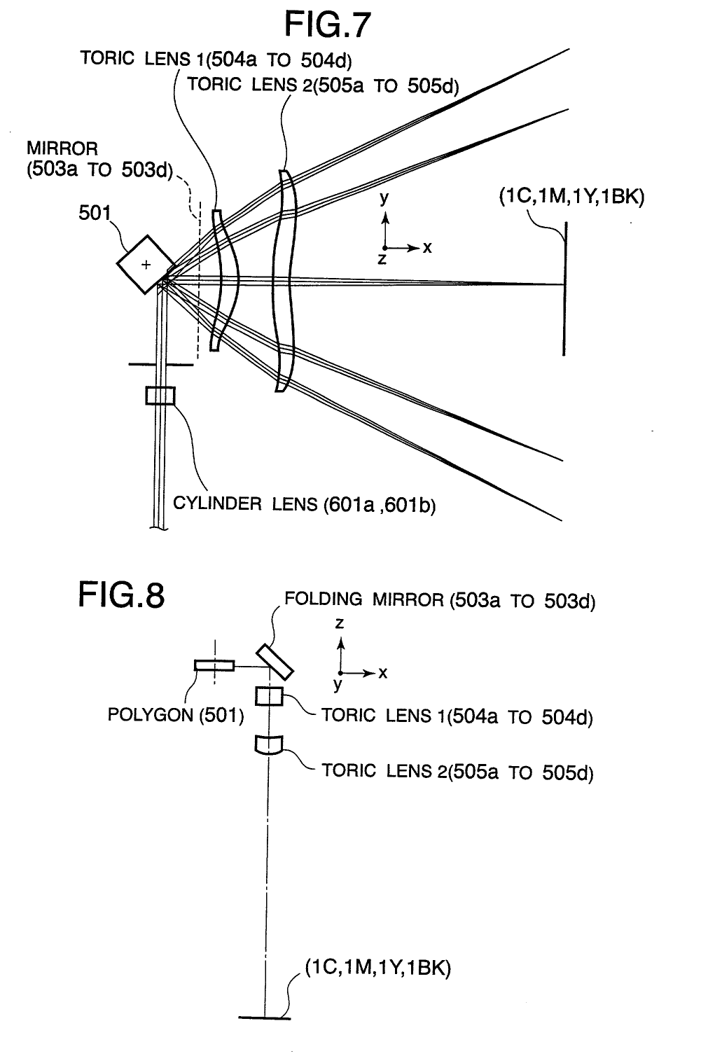

The scanning optical system used when the fluctuation amount of the scanning line is calculated is constructed by two aspherical plastic lenses as shown in FIG. 7. A shape of each lens has an aspherical surface whose main scanning direction can be expressed by a function of up to the 10th degree, and the aspherical surface is defined as follows when assuming that a cross point with the optical axis is set to an origin, the optical axial direction is set to an x axis, an axis which crosses perpendicularly to the optical axis in the main scanning cross section is set to a y axis, and an axis which crosses perpendicularly to the optical axis in the subscanning cross section is set to a z axis.

That is, the generating line direction corresponding to the main scanning direction is expressed by

$$x = \frac{{Y}^{2} / R}{1 + ( 1 - ( 1 + K ) {( Y / {R}^{2} )}^{1 / 2}} + {B}_{4} {Y}^{4} + {B}_{6} {Y}^{6} + {B}_{8} {Y}^{8} + {B}_{10} {Y}^{10}$$

(where, R is a radius of curvature; and K, B4, B6, B8, and B10 are aspherical coefficients)

The child line direction corresponding to the subscanning direction (direction which includes the optical axis and crosses perpendicularly to the main scanning direction) is expressed by

$$s = \frac{{z}^{2} / {r}^{′}}{{1 + {( 1 - Z / {r}^{′} )}^{2} )}^{1 / 2}}$$

where,

r′=r0(1+D2Y²+D4Y⁴+D6Y⁶+D8Y⁸+D10Y¹⁰)

(where, r0 is a radius of curvature of the child line on the optical axis; and D2, D4, D6, D8, and D10 are aspherical coefficient)

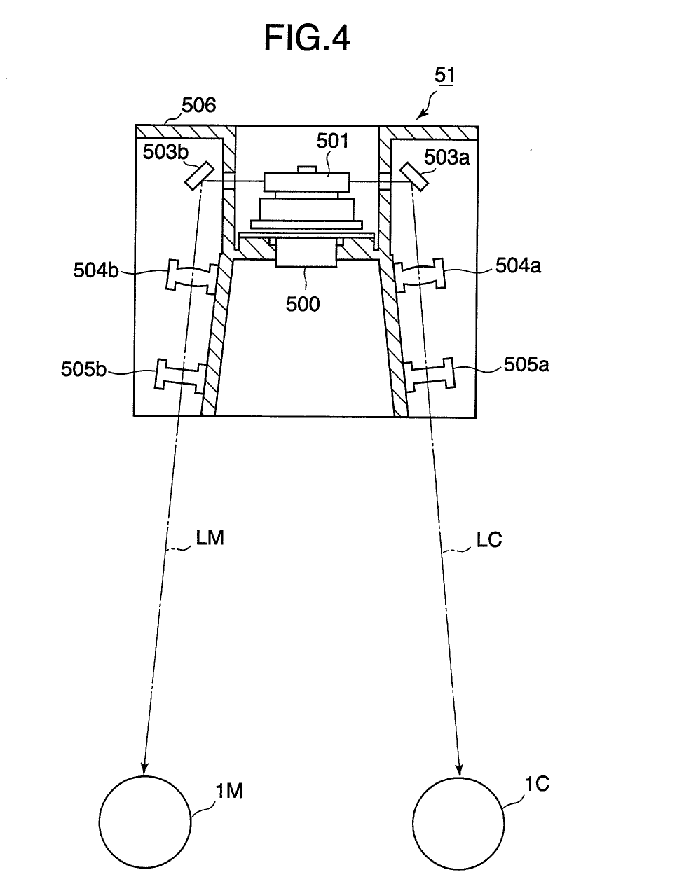

Even if the arrangement pitch of the image bearing bodies 1C, 1M, 1Y, and 1BK and the arrangement pitch of the folding mirrors 503a to 503d cannot be equalized for some reason, as shown in FIG. 4, by arranging them in a manner such that the folding mirrors 503a and 503b (503c and 503d) are set into a (90±α)° reflecting mode instead of a 90° reflecting mode so that the arrangement pitch of the folding mirrors 503a and 503b (503c and 503d) coincides with the arrangement pitch of the image bearing bodies 1C and 1M (1Y and 1BK) and the scanning lenses 504a and 504b (504c and 504d) and 505a and 505b (505c and 505d) are inclined at a desired angle, the arrangement pitch of the image bearing bodies 1C, 1M, 1Y, and 1BK can be set to a desired value.

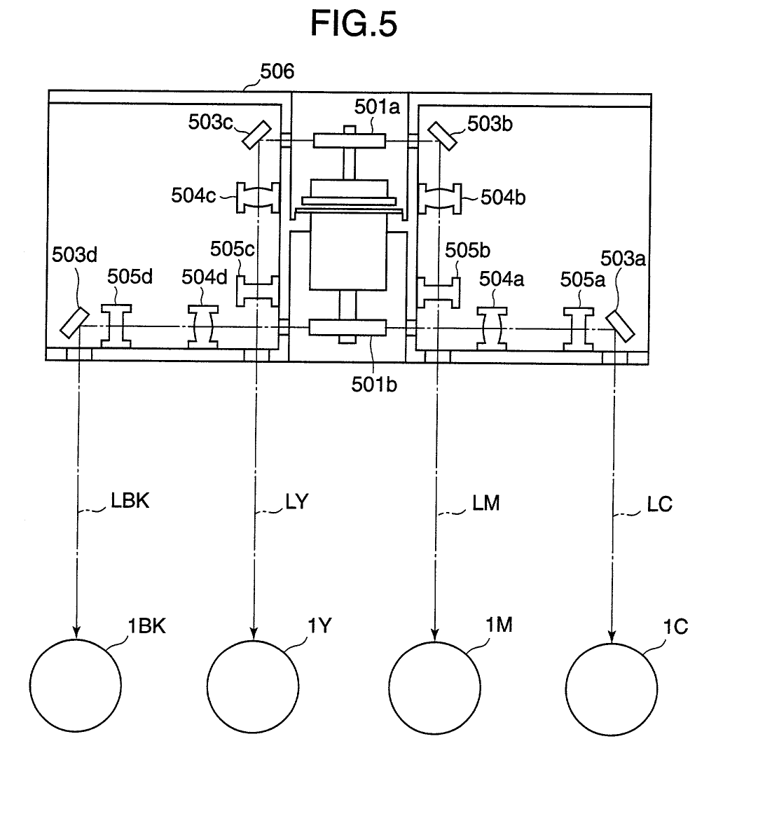

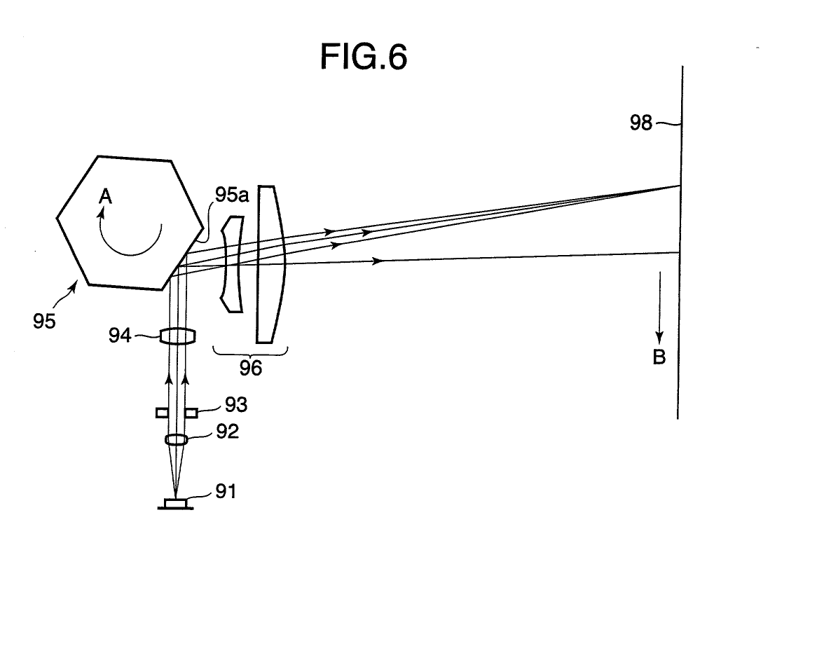

A construction of another embodiment shown in FIG. 5 can be also used.

There are four mirrors and four image bearing bodies. The deflecting means has two polygon mirrors. Each polygon mirror deflects two lights. The mirror and image bearing body are provided for each of the four deflected lights.

That is, rotary polygon mirrors 501a and 501b are attached at upper and lower positions of the deflector 500 at regular intervals which are equal to the arrangement pitch of the image bearing bodies 1C, 1M, 1Y, and 1BK. The folding mirrors 503b and 503c are arranged on both sides of the upper rotary polygon mirror 501a. The scanning lenses (504b and 504c) and (505b and 505c) are arranged under the folding mirrors 503b and 503c, respectively.

The scanning lenses 504a, 504d, 505a, and 505d and the folding mirrors 503a and 503d are horizontally arranged on both sides of the lower rotary polygon mirror 501b.

Since the arrangement pitch of the two folding mirrors 503b and 503c is almost the same as the arrangement pitch of the image bearing bodies 1M and 1Y, the luminous flux LM which passed through the rotary polygon mirror 501a, folding mirror 503b, and scanning lenses 504b and 505b is irradiated to the image bearing body 1M. Similarly, the luminous flux LY which passed through the rotary polygon mirror 501a, folding mirror 503c, and scanning lenses 504c and 505c is irradiated to the image bearing body 1Y.

The two luminous fluxes deflected by the other rotary polygon mirror 501b become the luminous flux LC which passes through the scanning lenses 504a and 505a and folding mirror 503a and the luminous flux LBK which passes through the scanning lenses 504d and 505d and folding mirror 503d, respectively. The luminous fluxes LC and LBK are irradiated onto the image bearing bodies 1C and 1BK, respectively. The arrangement pitch of the folding mirrors 503a and 503d are set to a value that is almost three times as large as the arrangement pitch of the image bearing bodies 1C, 1M, 1Y, and 1BK.

That is, the arrangement pitch of the mirrors (503b and 503c) provided for the two lights deflected by one polygon mirror 501a is almost the same as the arrangement pitch of the image bearing bodies. The arrangement pitch of the mirrors (503a and 503d) provided for the two lights deflected by the other polygon mirror 501b is equal to a value that is almost three times as large as the arrangement pitch of the image bearing bodies.

According to the embodiment as mentioned above, since the deflecting means is constructed by one deflecting means having two polygon mirrors and one scanning system is constructed by one folding mirror, the fluctuation of the irradiating position due to the environmental fluctuation of the scanning optical apparatus can be suppressed and the costs of the scanning optical apparatus can be reduced. The arrangement pitch of the rotary polygon mirrors attached to the deflector is set to the same value as that of the image bearing bodies, the arrangement pitch of one set of four folding mirrors is set to almost the same as that of the image bearing bodies, and the arrangement pitch of another pair of folding mirrors is set to the value that is almost three times as large as that of the image bearing bodies, respectively. Consequently, effects such that the image bearing bodies can be arranged in the same plane and the positioning and exchange of the image bearing bodies can be easily performed.

Although the embodiment of the invention has been described above, the invention is not limited to the foregoing embodiment but many modifications and variations are possible within the spirit and scope of the appended claims of the invention.

What is claimed is:

1. An image forming apparatus comprising:
a light source;
deflecting means for deflecting light emitted from said light source by a rotation;
a mirror for deflecting the light deflected by said deflecting means;
an image bearing body to which the light deflected by said mirror is irradiated; and
a lens for image-forming the light deflected by said deflecting means onto said image bearing body,
wherein a plurality of lights are deflected by said one deflecting means and only said one mirror exists in an optical path along which said one light deflected by said deflecting means reaches said image bearing body.

2. An image forming apparatus according to claim 1, wherein said mirror and said image bearing body are provided plurally, and said mirror and said image bearing body are provided for each of said plurality of lights deflected by said deflecting means.

3. An image forming apparatus according to claim 2, wherein an arrangement pitch of said mirrors and an arrangement pitch of said image bearing bodies are almost the same.

4. An image forming apparatus according to claim 1, wherein said deflecting means has one polygon mirror, said polygon mirror deflects two lights, and said mirror is provided for each of said two deflected lights.

5. An image forming apparatus according to claim 4, further comprising an optical box for containing at least said deflecting means and said two mirrors.

6. An image forming apparatus according to claim 4, wherein two said deflecting means are provided.

7. An image forming apparatus according to claim 1, wherein said mirror and said image bearing body are provided plurally, said deflecting means has two polygon mirrors, each of said polygon mirrors deflects two lights, and said mirror and said image bearing body are provided for each of said four deflected lights.

8. An image forming apparatus according to claim 7, wherein an arrangement pitch of said mirrors each of which is provided for each of said two lights deflected by one said polygon mirror is almost the same as an arrangement pitch of said image bearing bodies, and an arrangement pitch of said mirrors each of which is provided for each of said two lights deflected by the other polygon mirror almost three times as large as the arrangement pitch of said image bearing bodies.

9. An image forming apparatus according to claim 7, further comprising an optical box for containing at least said deflecting means and said four mirrors.

10. An image forming apparatus according to claim 1, wherein said mirror is provided in the optical path along which the light deflected by said deflecting means reaches said lens.

11. An image forming apparatus comprising:
a light source;
deflecting means for deflecting light emitted from said light source by a rotation;
a mirror for deflecting the light deflected by said deflecting means;
an image bearing body to which the light deflected by said mirror is irradiated; and
a lens for image-forming the light deflected by said deflecting means onto said image bearing body,
wherein in an optical path along which the light deflected by said deflecting means is directed toward said image bearing body, said lens is provided on a downstream side of said mirror.

12. An image forming apparatus according to claim 11, wherein said deflecting means includes a polygon mirror having a reflecting surface, and said lens corrects an inclination of the reflecting surface of said polygon mirror.

13. A scanning optical apparatus comprising:
a light source;
deflecting means for deflecting light emitted from said light source by a rotation;
a mirror for deflecting the light deflected by said deflecting means; and
a lens through which the light deflected by said mirror is transmitted.

14. A scanning optical apparatus according to claim 13, wherein said deflecting means includes a polygon mirror having a reflecting surface, and said lens corrects an inclination of the reflecting surface of said polygon mirror.
